(19) United States
(12) Patent Application Publication
(10) Pub. No.: US 2007/0241681 A1
(43) Pub. Date: Oct. 18, 2007

(54) Plasma display panel having reduced reflectance

(76) Inventors: Young-Gil Yoo, Suwon-si (KR); Sung-Yong Lee, Suwon-si (KR); Jin-Won Kim, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 11/783,712

(22) Filed: Apr. 11, 2007

(30) Foreign Application Priority Data
Apr. 12, 2006 (KR) 10-2006-0033198

(51) Int. Cl. H01J 17/49; H01J 9/24; H01J 9/00

(52) U.S. Cl. 313/582; 313/586; 313/587; 445/24; 445/25

(57) ABSTRACT

A plasma display panel having reduced reflectance and increased luminance efficiency includes multiple discharge electrodes formed on an inner surface of a front substrate, multiple barrier ribs formed between the front substrate and a rear substrate to partition multiple red, blue and green discharge cells, and at least one red, blue or green phosphor layer in each respective red, blue and green discharge cell, where the red and the blue phosphor layers are respectively colored with red and blue pigments.

### BACKGROUND OF THE INVENTION

1. Field of the Invention

The present invention relates to a plasma display panel. More particularly, the present invention pertains to a plasma display panel having a reduced reflectance, in which a phosphor layer and a barrier rib are colored in order to reduce the reflectance thereof.

2. Description of the Related Art

Plasma display panels are flat display devices which display desired numbers, letters, or graphics using visible light rays generated by exciting phosphors in a predetermined pattern by applying a discharge voltage between two substrates, between which a discharge gas may be sealed, and on which multiple electrodes may be formed. An appropriate pulse voltage may be applied to a specific addressing point where two electrodes of the multiple electrodes cross.

A general three-electrode surface discharge type plasma display panel may include front and rear substrates. Multiple X electrodes and multiple Y electrodes may be alternately formed on an inner surface of the front substrate, and the X and Y electrodes may be completely covered by a front dielectric layer. A protective layer may be formed on the front dielectric layer. Multiple address electrodes may be formed on an inner surface of the rear substrate in a direction crossing the X and Y electrodes. The address electrodes may be completely covered by a rear dielectric layer. Multiple barrier ribs that partition multiple discharge cells may be disposed between the front and rear substrates. A phosphor layer generating red, green, or blue color may be coated in each discharge cell by being formed on sidewalls of the barrier ribs that partition a corresponding discharge cell and on the portion of the rear dielectric layer that may be in the same discharge cell.

In a general plasma display panel having the above configuration, when an electrical signal is applied between the address electrodes and the Y electrode, discharge cells for generating light may be selected. When an electrical signal is alternately applied to the X and Y electrodes, visible light may be emitted from the phosphor layers coated in the selected discharge cells, thereby displaying a single frame of a moving image.

However, the general plasma display panel has a drawback of high external light reflection in comparison with other flat panel devices since a dielectric layer, a barrier rib and a phosphor layer included in the plasma display panel may have a white color. Since the high external light reflection reduces contrast of the plasma display panel more than other flat panel devices, a produced image quality of the plasma display panel may be reduced.

Therefore, various methods for reducing the external light reflection of the plasma display panel have been studied. For example, methods have been used where the front dielectric layer may be colored blue, or where the barrier ribs may be colored. However, since the phosphor layers that produce red, green and blue light are themselves white, the external light reflection of the plasma display panel may not be remarkably reduced. In addition, a luminous efficiency of the plasma display panel may deteriorate.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention is therefore directed to a plasma display panel which substantially overcomes one or more of the problems due to the limitations and disadvantages of the related art.

It is therefore a feature of an embodiment of the present invention to provide a plasma display panel having a reduced reflectance in which a barrier rib and a phosphor layer may be colored with different colors to provide a reduced reflectance, so that the luminous efficiency of the phosphor layer may be maximized.

At least one of the above and other features and advantages of the present invention may be realized by providing a plasma display panel which may include a front substrate and a rear substrate formed opposite to each other, multiple discharge electrodes formed between the front substrate and the rear substrate, multiple barrier ribs between the front substrate and the rear substrates to partition multiple red, blue and green discharge cells, and at least one red, blue or green phosphor layers in each respective red, blue and green discharge cell, where at least a part of the barrier ribs may be colored, and at least one of the red or the blue phosphor layers may be respectively colored with red or blue pigments.

The red and the blue phosphor layers may be respectively colored with red or blue pigments having substantially the same color as the light produced by the red or the blue phosphor layers, respectively. A coloring ratio of the red phosphor layer may be about 0.1 to 5 wt %. The red phosphor layer may be (Y,Gd)BO₃:Eu³⁺. The red pigment may be α-Fe₂O₃. A coloring ratio of the blue phosphor layer may be about 0.1 to 5 wt %. The blue phosphor layer may be BaMgAl₁₀O₁₇:Eu²⁺. The blue phosphor layer may be CaMgSi₂O₈:Eu²⁺. The blue phosphor layer may be a mixture of BaMgAl₁₀O₁₇:Eu²⁺ and CaMgSi₂O₈:Eu²⁺. The blue pigment may be Co₂O₃. The barrier ribs may be a glass powder containing at least one organic vehicle and at least one filler. The barrier rib colored layer may contain a green pigment. The barrier rib colored layer may include CuO. A subtractive color may be formed by a colored phosphor layer and a colored barrier rib. The colors of a colored phosphor layer and a colored barrier rib may produce black. The green phosphor layer may contain substantially no pigment.

At least one of the above and other features and advantages of the present invention may be realized by providing a method of manufacturing a plasma display panel, including arranging multiple discharge electrodes on an inner surface of a front substrate, forming multiple barrier ribs between the front substrate and a rear substrate so as to partition multiple red, blue and green discharge cells, and forming at least one red, blue or green phosphor layer in each respective red, blue or green discharge cell, where at least a part of the barrier ribs may be colored, and at least one of the red or the blue phosphor layers may be respectively colored with red or blue pigments.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1 illustrates a partial perspective view of a plasma display panel according to an embodiment of the present invention; and

FIG. 2 illustrates a cross-sectional view of the plasma display panel taken along a line I-I′ of FIG. 1.

### DETAILED DESCRIPTION OF THE INVENTION

Korean Patent Application No. 10-2006-0033198, filed on Apr. 12, 2006, in the Korean Intellectual Property Office, and entitled: “Plasma Display Panel Having Reduced Reflectance,” is incorporated by reference herein in its entirety.

The present invention will now be described more fully hereinafter with reference to the accompanying drawings, in which exemplary embodiments of the invention are illustrated. The invention may, however, be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

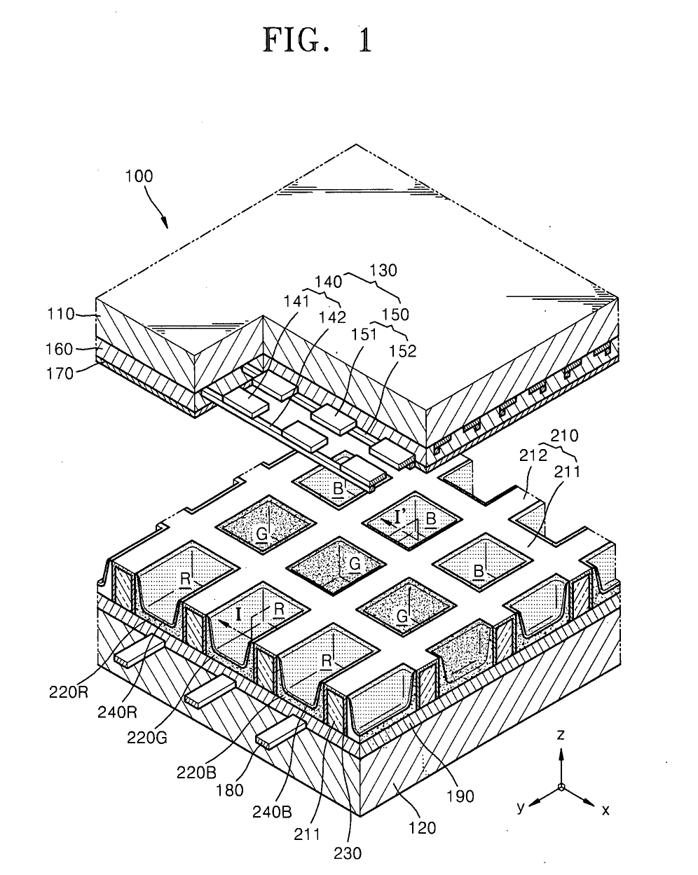

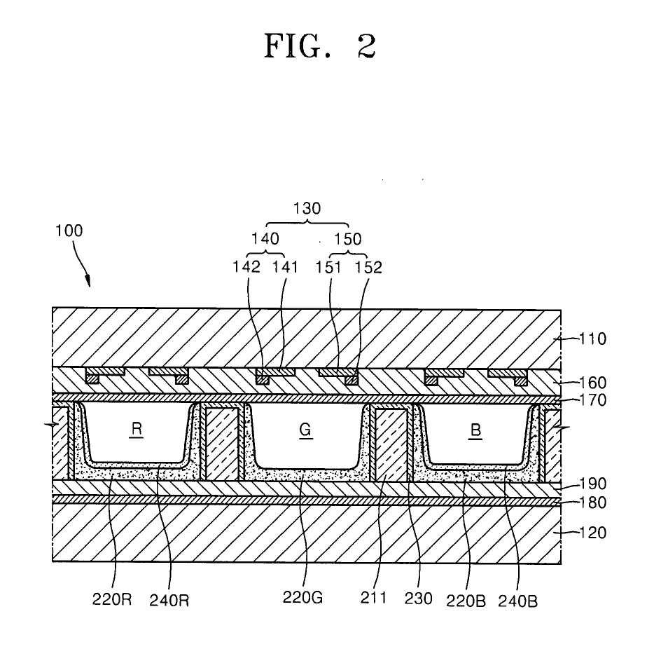

FIG. 1 illustrates a partially taken perspective view of a plasma display panel 100 according to an embodiment of the present invention. FIG. 2 illustrates a cross-sectional view of the plasma display panel 100 taken-along a line I-I′ of FIG. 1.

Referring to FIGS. 1 and 2, the plasma display panel 100 may include a front substrate 110 and a rear substrate 120 arranged substantially in parallel with the front substrate 110. Since frit glass (not shown) may be coated along edges of facing sides of the front substrate 110 and the rear substrate 120, an interior discharge space of the plasma display panel 100 may be hermetically sealed from the outside.

The front substrate 110 may be formed of a transparent material, e.g., soda lime glass, borosilicate glass, etc. Alternatively, the front substrate 110 may be, e.g., a translucent substrate, a colored substrate, a reflective substrate, etc.

Multiple X electrodes 140 and Y electrodes 150 constituting sustain discharge electrode pairs 130 may be on an inner surface of the front substrate 110 along an X direction of the plasma display panel 100. The X electrodes 140 and Y electrodes 150 may be alternately arranged along the Y direction of the plasma display panel 100. A single X electrode 140 and a single Y electrode 150 may correspond to a single discharge cell.

The multiple X electrodes 140 may be on the inner surface of the front substrate 110. Each of the X electrodes 140 may include multiple first transparent electrodes 141, each corresponding to a single discharge cell along the X direction of the plasma display panel 100, and a first bus electrode 142 electrically connecting the multiple first transparent electrodes 141 with each other. The first transparent electrode 141 may have a rectangular shape, and the first bus electrode 142 have a stripe shape, but they are not limited thereto.

Each of the Y electrodes 150 may have substantially the same shape as that of each of the X electrodes 140. Each of the Y electrodes 150 may include multiple second transparent electrodes 151, each formed to correspond to a single discharge cell along the X direction of the plasma display panel 100. A second bus electrode 152 may connect the multiple second transparent electrodes 151. A single second transparent electrode 151 may be arranged to correspond to a single discharge cell so as to be separated at a predetermined interval from a corresponding first transparent electrode 141 formed in the same discharge cell, thus forming a discharge gap.

Each of the first transparent electrodes 141 and the second transparent electrodes 151 may be made of a transparent conductive material, e.g., indium tin oxide (ITO), indium zinc oxide (IZO), etc., in order to increase the effective emission area of the plasma display panel 100. Each of the first bus electrodes 142 and the second bus electrodes 152 may have a multilayer structure using a metal having good conductivity, e.g., silver (Ag) paste and chromium-copper-chromium (Cr—Cu—Cr) alloy, in order to improve the overall electrical conductivities of the X electrodes 140 and the Y electrodes 150.

A space formed between two pairs of the X and Y electrodes 140 and 150 adjacent to each other may correspond to a non-discharge region. A black stripe layer may be formed on the non-discharge region in order to increase contrast.

A front dielectric layer 160 may cover the X electrode 140 and the Y electrode 150. The front dielectric layer 160 may be formed of a material having a high dielectric constant, e.g., ZnO—B₂O₃—Bi₂O₃. The front dielectric layer 160 may be selectively printed on only portions on which the sustain discharge electrode pairs 130 are formed. Alternatively, the front dielectric layer 160 may be printed on the entire surface of the front substrate 110.

A protective layer 170 may be formed on the front dielectric layer 160 in order to prevent damage to the front dielectric layer 160 and increase the amount of light emitted through a secondary emission. The protective layer 170 may be composed of, e.g., magnesium oxide (MgO).

The rear substrate 120 may be composed of substantially the same material as that of the front substrate 110.

An address electrode 180 may be on an inner surface of the rear substrate 120 and may intersect the sustain discharge electrode pairs 130. A rear dielectric layer 190 may cover the address electrodes 180. The rear dielectric layer 190 may be formed from at least one material having a high dielectric constant, e.g., PbO—B₂O₃—SiO₂, etc.

Barrier ribs 210 may be arranged between the front substrate 110 and the rear substrate 120 to be connected with the front substrate 110 and the rear substrate 120. The barrier ribs 210 may partition multiple discharge cells. The barrier ribs 210 may include multiple first barrier ribs 211 formed in an X direction of the plasma display panel 100, and multiple second barrier ribs 212 formed in a Y direction of the plasma display panel 100. The first barrier ribs 211 may be integrally extended in a direction substantially perpendicular to the second barrier ribs 212 in a grid arrangement to partition the multiple discharge cells.

Alternatively, the barrier ribs 210 may be formed as various types, e.g., a meander type, a delta type, a waffle type, a honeycomb type, etc. According to a current embodiment of the present invention, the cross section of the discharge space defined by the barrier rib 210 may be a square. In addition, the cross section of the discharge space may be embodied in various forms, e.g., a polygon, a circle, an oval, etc.

A discharge gas such as Ne—Xe and/or He—Xe may be injected into the discharge cells defined by the front substrate 110, the rear substrate 120 and the barrier rib 210.

Phosphor layers 220R, 220G and 220B may be formed in each discharge cell and excited by ultraviolet rays generated by the discharge gas to emit visible light. By allowing each discharge cell to have a phosphor layer formed of one of multiple emission colors, such as red phosphor layer 220R, green phosphor layer 220G, or blue phosphor layer 220B, the plasma display panel 100 may emit multiple colors for forming full color images. In addition, the phosphor layers 220R, 220G and 220B may be coated on any part of a discharge cell. In an embodiment of the present invention, the phosphor layer 220R, 220G and 220B may be coated on the inner surface of the rear substrate 120 and on the barrier ribs 210 at a predetermined thickness.

Here, at least one part of the barrier ribs 210 and at least one phosphor layer of the phosphor layers 220R and 220B may be colored with different colors. In order to maintain the luminance, phosphor layer 220G may not be substantially colored or may be only slightly colored. That is, the phosphor layer 220G may not contain any pigment.

Hereinafter, an embodiment of the present invention will now be described more fully.

The barrier ribs 210 may be formed between the front substrate 110 and the rear substrate 120 to define the multiple discharge cells. The barrier ribs 210 may be formed of dielectric materials which may induce electrons when discharge occurs. The barrier ribs 210 may be formed of glass powder to which one or more organic vehicles and/or one or more of various fillers may be added.

A phosphor layer 220R, 220G or 220B may be formed in each of the discharge cells defined by the barrier ribs 210.

According to the present invention, the phosphor layers may include a red phosphor layer 220R, a green phosphor layer 220G and a blue phosphor layer 220B, but is not limited thereto. That is, a phosphor layer may be substituted by other colors of phosphors layers or, alternatively, one or more of the phosphor layers 220R, 220G or 220B may have other color phosphors added.

Any suitable phosphor material may be used to form the phosphor layers 220R, 220G and 220B. As examples, the red phosphor layer 220R may be formed of, e.g., (Y,Gd)BO₃:Eu³⁺, the green phosphor layer 220G may be formed of, e.g., Zn₂SiO₄:Mn²⁺, and the blue phosphor layer 220B may be formed of, e.g., BaMgAl₁₀O₁₇:Eu²⁺. Alternatively, the blue phosphor layer 220B may be formed of, e.g., CaMgSi₂O₈:Eu²⁺, a mixture of BaMgAl₁₀O₁₇:Eu²⁺ and CaMgSi₂O₈:Eu²⁺, etc. Also, variations of these phosphor stoichiometries may be used.

Since the barrier rib 210 may be white, a barrier rib colored layer 230 may be formed on the barrier ribs 210 in order to decrease a reflectance of the plasma display panel 100. The barrier rib colored layer 230 may include a green pigment formed of, e.g., CuO.

The red phosphor layer 220R and the blue phosphor layer 220B may be colored with pigments having substantially the same color as the light produced by the red phosphor layer 220R and the blue phosphor layer 220B, respectively. A red colored layer 240R may be coated on the red phosphor layer 220R. The red colored layer 240R may include a red pigment, e.g., α-Fe₂O₃. In addition, a blue colored layer 240B may be coated on the blue phosphor layer 220B. The blue colored layer 240B may include a blue pigment, e.g., Co₂O₃. Alternately, the red phosphor layer 220R and the blue phosphor layer 220B may be formed by mixing materials, which may be used in the red colored layer 240R and the blue colored layer 240B, on the red phosphor layer 220R and the blue phosphor layer 220B, respectively.

A green colored layer may not be coated on the green phosphor layer 220G. Alternatively, the green colored layer may be coated on the green phosphor layer 220G in a relatively small amount as compared to the red phosphor layer 220R and the blue phosphor layer 220B.

The red phosphor layer 220R, the green phosphor layer 220G and the blue phosphor layer 220B may be naturally white. However, the red colored layer 240R and the blue colored layer 240B may be naturally red and blue, respectively.

Each of the coloring ratios of the red phosphor layer 220R and blue phosphor layer 220B may be, e.g., about 0.1 to 5 wt %, preferably, about 0.5 to 1 wt %. In addition, if the green colored layer is formed, the coloring ratio of the green phosphor layer may be about 0 to 0.5 wt %.

The plasma display panel 100 having the above structure may be operated as follows.

First, when a predetermined pulse voltage is applied between the address electrode 180 and the Y electrode 150 from an external power supply, a discharge cell to emit light may be selected. Wall charges may accumulate on the inner side surface of the selected discharge cell.

Next, when a positive voltage is applied to the X electrode 140 and a relatively higher voltage is applied to the Y electrode 150, the wall charges may move due to the voltage difference between the X and Y electrodes 140 and 150.

The wall charges move to collide with the components of the discharge gas in the discharge cell. Thus, the wall charges may be discharged to generate plasma. The discharge may be fired from a gap between the X and Y electrodes 140 and 150, in which a relatively strong electric field may be generated, and the discharge may be diffused to the outside of the X and Y electrodes 140 and 150.

When the voltage between the X and Y electrodes 140 and 150 is lower than a discharge voltage, the discharge may not occur, i.e., the discharge may cease. Space charges and wall charges may be generated in the discharge cell.

When the polarities of the voltage applied between the X and Y electrodes 140 and 150 are interchanged, the discharge may reoccur by help of the wall charges. When the polarities of the X and Y electrodes 140 and 150 are interchanged, the initial discharge process may be repeated. Through repeating the above process, discharge can occur stably.

Ultraviolet rays generated by the discharge excites the fluorescent material, which may be coated on each of the discharge cells, of the red, green and blue phosphor layers 220R, 220G and 220B. Visible light rays may be obtained through this process. The resulting visible rays may be emitted through the discharge cell, and this process may be performed over the entire plasma display panel 100 to produce a still image or a moving picture.

The red colored layer 240R and the blue colored layer 240B may become color-mixed with the barrier rib colored layer 230. The luminous efficiency of the phosphor layer may thus be lowered to be less than about 30%. In addition, reflection of external light may be reduced. The luminous efficiency of the green phosphor layer 220G may constitute substantially more than about 60% of the overall luminous efficiency of the plasma display panel 100. Since the green phosphor layer 220G may not be colored (or only slightly colored), a high luminous efficiency of the green phosphor layer 220G may be maintained.

The red colored layer 240R and the blue colored layer 240B may be color-mixed with the barrier rib colored layer 230, which may be formed on the barrier ribs 210, to produce a subtractive color mixture producing black.

Table 1 shows reflectance and full white values of experiments performed on the plasma display panel 100 according to an embodiment of the present invention and of Comparative Examples 1-5.

TABLE 1

| | | Relative | Full white |
|---|---|---|---|
| Coloring | Pigment | reflectance | brightness (F/W) |
| Comparative Example 1 | α-Fe₂O₃ | 0.90 | 0.97 |
| Comparative Example 2 | CuO | 0.96 | 0.84 |
| Comparative Example 3 | Co₂O₃ | 0.93 | 0.98 |
| Comparative Example 4 | — | 1 | 1 |
| Comparative Example 5 | The mixture | 0.84 | 0.89 |
| Example 1 | The mixture | 0.83 | 0.98 |

Comparative Example 1 uses a red phosphor layer with a red pigment. Comparative Example 2 uses a green phosphor layer colored with a green pigment. Comparative Example 3 uses a blue phosphor layer colored with a blue pigment. Comparative Example 4 uses uncolored phosphor layers. Comparative Example 5 uses red, green and blue phosphor layers colored with red, green and blue phosphor layers, respectively. Example 1 uses red and blue phosphor layers colored with red and blue pigments, respectively. In Example 1, the green phosphor layer is not colored, and the barrier ribs are colored with a green pigment.

Referring to Table 1 , in Comparative Example 1, a relative reflectance is about 0.9 and a full white brightness (F/W) is about 0.97. In Comparative Example 2, the relative reflectance is about 0.96 and the full white brightness is about 0.84. In Comparative Example 3, the relative reflectance is about 0.93 and the full white brightness is about 0.98. In Comparative Example 4, the relative reflectance is about 1 and a full white brightness is about 1. In Comparative Example 5, the relative reflectance is about 0.84 and the full white brightness is about 0.89. On the other hand, in Example 1 of the present invention, the relative reflectance is about 0.83 and a full white brightness is about 0.98.

When the red, green and blue phosphor layers are colored with the red, green and blue pigments, respectively, it is observed that the reflectance may be about 16% lower than when the red, green and blue phosphor layers are not colored with the red, green and blue pigments. Also, the full white brightness (F/W) when the red, green and blue phosphor layers are all colored may be about 11% lower than the full white brightness (F/W) compared to when the red, green and blue phosphor layers are not colored.

In the technology of the present invention, when only red and blue phosphor layers are colored with red and blue pigments, respectively, the brightness of the red and blue phosphor layers may be reduced by coloring the red and blue phosphor layers. On the other hand, since the brightness of the green phosphor layer, which may be severely decreased by coloring, is not decreased because the green phosphor layer is not colored (or only slightly colored), the full white brightness (F/W) may be only about 2% lower than when the red, green and blue phosphor layers are not colored. However, in accordance with the present invention, when only red and blue phosphor layers are colored with red and blue pigments, respectively, the reflectance may be reduced by about 17% in comparison with the case when the red, green and blue phosphor layers are not colored.

As described above, according to the present invention, the plasma display panel may have reduced reflectance and may also maintain the luminance efficiency of the green phosphor layer. Accordingly, the overall luminance efficiency of the plasma display panel may be remarkably and significantly increased.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A plasma display panel, comprising:
a front substrate and a rear substrate formed opposite to each other;
a plurality of discharge electrodes formed between the front substrate and the rear substrate;
a plurality of barrier ribs between the front substrate and the rear substrate to partition a plurality of red, blue and green discharge cells; and
at least one red, blue or green phosphor layer in each respective red, blue and green discharge cell,
wherein at least a part of the barrier ribs is colored, and at least one of the red or the blue phosphor layers is respectively colored with red or blue pigments.

2. The plasma display panel as claimed in claim 1, wherein the at least one of the red or the blue phosphor layers is respectively colored with red or blue pigments having substantially the same color as a light produced by the red or the blue phosphor layers, respectively.

3. The plasma display panel as claimed in claim 1, wherein a coloring ratio of the red phosphor layer is about 0.1 to 5 wt %.

4. The plasma display panel as claimed in claim 1, wherein the red phosphor layer comprises (Y,Gd)BO₃:Eu³⁺.

5. The plasma display panel as claimed in claim 1, wherein the red pigment comprises α-Fe₂O₃.

6. The plasma display panel as claimed in claim 1, wherein a coloring ratio of the blue phosphor layer is about 0.1 to 5 wt %.

7. The plasma display panel as claimed in claim 1, wherein the blue phosphor layer comprises BaMgAl₁₀O₁₇:Eu²⁺.

8. The plasma display panel as claimed in claim 1, wherein the blue phosphor layer comprises CaMgSi₂O₈:Eu²⁺.

9. The plasma display panel as claimed in claim 1, wherein the blue phosphor layer comprises a mixture of BaMgAl₁₀O₁₇:Eu²⁺ and CaMgSi₂O₈:Eu²⁺.

10. The plasma display panel as claimed in claim 1, wherein the blue pigment comprises Co₂O₃.

11. The plasma display panel as claimed in claim 1, wherein the barrier ribs comprise a glass powder containing at least one organic vehicle and at least one filler.

12. The plasma display panel as claimed in claim 1, further comprising a barrier rib colored layer containing a green pigment.

13. The plasma display panel as claimed in claim 12, wherein the barrier rib colored layer comprises CuO.

14. The plasma display panel as claimed in claim 1, wherein a subtractive color is formed by a colored phosphor layer and a colored barrier rib.

15. The plasma display panel as claimed in claim 1, wherein the colors of at least one of the colored phosphor layers and a colored barrier rib produce black.

16. The plasma display panel as claimed in claim 1, wherein the green phosphor layer contains substantially no pigment.

17. A method of manufacturing a plasma display panel, comprising:
arranging a plurality of discharge electrodes on an inner surface of a front substrate;
forming a plurality of barrier ribs between the front substrate and a rear substrate so as to partition a plurality of red, blue and green discharge cells; and
forming at least one red, blue or green phosphor layer in each respective red, blue or green discharge cell,
wherein at least a part of the barrier ribs is colored, and at least one of the red or the blue phosphor layers is respectively colored with red or blue pigments.

18. The method of manufacturing the plasma display panel as claimed in claim 16, wherein the at least one of red and the blue phosphor layers is respectively colored with red or blue pigments having substantially the same color as a light produced by the red or the blue phosphor layers, respectively.

19. The method of manufacturing the plasma display panel as claimed in claim 17, wherein the red phosphor layer comprises (Y,Gd)BO₃:Eu³⁺, and the blue phosphor layer comprises at least one of BaMgAl₁₀O₁₇:Eu²⁺ or CaMgSi₂O₈:Eu²⁺.

20. The method of manufacturing the plasma display panel as claimed in claim 17, wherein the green phosphor layer contains substantially no pigment.
